(19) United States
(12) Patent Application Publication
(10) Pub. No.: US 2023/0310908 A1
(43) Pub. Date: Oct. 5, 2023

(54) RESPIRATORY PROTECTION MASK

(71) Applicant: embrace Technologies GmbH, Berlin (DE)

(72) Inventor: Carlos SCHREIB, Berlin (DE)

(73) Assignee: embrace Technologies GmbH, Berlin (DE)

(21) Appl. No.: 18/019,532

(22) PCT Filed: Sep. 4, 2020
(86) PCT No.: PCT/EP2020/074854

§ 371 Date: Feb. 3, 2023

(51) Int. Cl. A62B 18/02; A62B 23/02; A62B 18/00; A62B 18/08

(52) U.S. Cl. CPC A62B 18/02; A62B 23/02; A62B 18/006; A62B 18/082; A62B 18/088

(57) ABSTRACT

A respiratory protection mask is disclosed. In one example, the respiratory protection mask comprises an upper portion, a lower portion, and a respiratory filter. The respiratory filter comprises an air outlet, and is arranged in, on and/or at the upper portion such that an inhaled airflow can run substantially straight from the air outlet of the respiratory filter through the upper portion, towards the lower portion and/or to a nose of a mask wearer when the respiratory protection mask is worn by the mask wearer.

### TECHNICAL FIELD

Embodiments of the present invention relates to respiratory protection masks, in particular to respective full-face masks.

### BACKGROUND

Breathing masks also referred to as respiratory protection masks are used to supply breathing gas to persons who work in or are required to stay in an atmosphere that is harmful to their respiratory system. The air to be breathed is either cleaned or freed from pollutants via one or more filters, or a breathing gas is fed from a cylinder reservoir via a hose line into the protective mask. Respiratory protection masks can be designed as full-face masks (standardized according to EN 136) or as half and quarter masks (EN 140).

Further, airborne germs (pathogens) such as bacteria, for example tuberculosis bacteria and viruses, such as influenza and corona viruses, may pose major challenges to the health of medical personal, patients, even the whole population of a country, and in the event of a pandemic possibly even worldwide, respectively.

Full-face masks usually have a mask body made of silicone or rubber, one or two viewing windows in a sealing frame, an exhalation valve, sometimes a mask strap, an inner mask or air channels, and a connector for a regulator (regulator) or a breathing filter (also referred to as respiratory filter). The mask strap can also consist of a system that braces the mask and a helmet together (helmet-mask combination).

An inner mask may be used to reduce a functional dead space. In conventional respirators, breathing air is brought into the mask body via control valves and then passes over the viewing window that may be implemented as a visor, thus preventing fogging of the viewing window. If no inner mask is used, air channels may be installed instead, in which the air can also sweep along the viewing window.

A further distinction is made between so-called normal pressure masks and so-called overpressure masks. With normal pressure masks, the pressure inside the mask corresponds to the ambient pressure. The internal mask pressure may be controlled and adjusted by a regulator. In contrast to the normal pressure mask, the regulator ensures an overpressure, e.g. 400 Pa (4 mbar), in the breathing mask.

In addition to medical applications, military applications, breathing masks are widely used by firefighters and in occupational safety. There is therefore a constant need to improve the properties of respirators.

In view of the above, respiratory protection masks according to the independent claims are provided. The respiratory protection masks described herein have a lower inhalation resistance, a more favorable weight distribution and/or allow improved communication.

### SUMMARY

According to an embodiment, a respiratory protection mask includes an upper portion, a lower portion and a respiratory filter including an air outlet. The air outlet, typically a major portion of the respiratory filter, more typically the whole respiratory filter including an air inlet is arranged in, on and/or at the upper portion such that an inhaled airflow can run substantially straight from the air outlet of the respiratory filter through the upper portion, towards the lower portion and/or to a nose of a mask wearer when the respiratory protection mask is worn by the mask wearer. In this way, an inhalation resistance of the mask can be significantly reduced compared to the airflow in conventional masks. Because the masks are often worn in hazardous situations, for a longer time and/or during physical exertion, the wearer is less fatigued.

In particular, the respiratory filter may be arranged on and/or at the upper portion such that the inhaled airflow can run substantially straight from the air outlet of the respiratory filter through the upper portion, towards the lower portion and/or to a nose of the mask wearer.

For example, the respiratory protection mask may have a respiratory filter arranged on and/or at the respiratory protection mask in such a way that, when the respiratory protection mask is worn (in place), an inhaled airflow passes substantially straight from the respiratory filter to the nose of a mask wearer.

The respiratory filter may also be arranged at least partially in the upper portion such that the inhaled airflow can run substantially straight downwards from the air outlet of the respiratory filter through (a remaining part of) the upper portion, towards the lower portion and/or to a nose of the mask wearer.

The respiratory filter may even be completely integrated and/or arranged within the upper portion.

According to an embodiment, the inhaled airflow (also referred to as inhalation airflow) is essentially vertical from a forehead area to the nose of the mask wearer.

According to a further embodiment, which can be combined with the previous embodiment, the inhaled airflow runs from a temple area to the nose of the mask wearer.

Generally speaking, the airflow runs downward from an area above the wearer's nose. In particular, the respiratory filter may be located above the wearer's nose. This routing of the airflow is different from that of conventional masks, where the filter is typically positioned at a slight downward angle in front of the wearer's mouth.

In particular, the inhaled airflow may be deflected less than 90°, preferably less than 60°, especially preferably less than 45°, on its way from the respiratory filter to the nose of the mask wearer. Any diversion of the inhalation flow increases the inhalation resistance in the mask, although the resistance also depends on the strength of the airflow. In particular, deflections of 180° (reversal of the direction of flow) increase the inhalation resistance enormously.

Typically, an exhaled airflow runs substantially perpendicular to the chin of the mask wearer. In this way, the advantageous, substantially straight-line flow of air is maintained in the mask. More typically, the inhaled airflow and the exhaled airflow (also referred to as exhalation airflow) do not overlap: Accordingly, only little or no turbulence occurs.

The respiratory filter typically includes a curved forehead-facing side, and/or a curved frontal side arranged opposite the forehead-facing side, more typically curved forehead-facing side and a curved frontal side arranged opposite the forehead-facing side.

In particular, the respiratory filter may, in a cross-section perpendicular to a (mean) direction of the inhaled airflow be at least substantially sickle-shaped.

Due to using a respiratory filter with curved forehead-facing side and/or a curved frontal side and an at least substantially sickle-shaped respiratory filter, respectively, the inhalation resistance (air resistance) can be particularly low.

The forehead-facing side and/or the frontal side, typically both, may extend in direction of the air flow between and air inlet of the respiratory filter and the outlet.

The forehead-facing side and/or the frontal side, typically both, may be at least substantially band-shaped, at least in a respective central portion.

Further, the respiratory filter may include one, several or even a plurality of air slits arranged between the forehead-facing side and the frontal side.

Typically, each air slit extends into a first direction which is at least substantially parallel to the direction of the inhaled airflow, for example a vertical direction,

Further, each air slit extends typically extends into a respective second direction which is at least substantially perpendicular to the forehead-facing side and/or the frontal side.

Accordingly, neighboring air slit may be tilted with respect to each other in the cross-section perpendicular to a direction of the inhaled airflow.

A radius of curvature of the forehead-facing side and/or the frontal side, in particular in the cross-section perpendicular to a direction of the inhaled airflow, is typically in a range from about 9 cm to about 90 cm, in particular in a range from about 10 cm to about 30 cm. Note that the radius of curvature of the forehead-facing side and/or the frontal side may depend on the head size of the wearer.

The forehead-facing side and/or the frontal side may be provided by a filter body or filter housing, in the following also referred to as housing.

The filter body or housing is typically made of a synthetic material.

Further, the filter body or housing may have a handle. Accordingly, inserting, removing and/or replacing of the respiratory filter may be facilitated.

The respiratory protection mask may include a main body providing a receptacle the respiratory filter.

The respiratory filter may be removably attached to the main body and/or removably arranged in the receptacle.

Further, the filter body or housing may have a guide element fitting with a counterpart provided by the main body, in particular by the receptacle.

In certain embodiments, the respiratory filter can be removed from and/or inserted into the receptacle in a direction which is at least substantially perpendicular to the air outlet.

Alternatively, the respiratory filter may be removed from and/or inserted into the receptacle in a direction which is at least substantially parallel to the air outlet, typically only if the mask is not worn by the mask wearer.

The filter body or housing may be made in one piece.

Alternatively, the filter body or housing may be made in two or even more pieces, and/or can be opened and/or closed. Accordingly, inserting, removing and/or replacing of a filter material arranged in the filter body or housing may be facilitated.

The filter material may include or be a filter material for harmful or even toxic gases, odors and/or particulate matter, i.e. microscopic particles of solid or liquid matter suspended in the air, in particular with a size down to at least 500 nm, 200 nm or even 50 nm. The filter material is typically suitable for filtering air or even cleaning air from one or more types of particulate matter such as fine dust, droplets, aerosols, viruses, and/or bacteria. However, this may depend on the intended application. For example, an FFP2 filter material or even an FFP3 filter material may be used in to filter the air from fine dust as well as droplets and/or aerosols potentially comprising viruses and bacteria. Alternatively or in addition, an active charcoal may be used (in particular for filtering odors and at least potentially harmful gases such as NOx). In other words, the filter material may include two or more different filter materials.

The respiratory filter may be arranged substantially above the nostrils of the mask wearer when the respiratory protection mask is worn.

In particular, the respiratory filter may be arranged in the forehead region of the mask wearer when the mask is worn (put on).

Alternatively or in addition, the respiratory filter is located laterally on the wearer's head when the mask is worn, preferably in the temple area.

By arranging the filters in the forehead area and/or laterally on the head of the mask wearer, a different weight distribution of the mask is achieved compared to conventional masks. In conventional masks, the respiratory filter is located in front of the wearer's mouth and typically protrudes downward at an angle. This causes the respiratory filter, which can weigh as much as 300 grams, to exert a constant tilting moment on the wearer's head. This tires the neck muscles of the mask wearer and can lead to neck pain and tension. In addition, such a respiratory filter may obscure the view, in particular the view of a floor directly in front of the mask wearer. This can endanger the mask wearer, especially in situations where liquids or other hazardous materials are on the floor.

The position of the respiratory filter above the nostrils of a mask wearer leads to a weight distribution of the mask, which results in a reduced tilting moment and thus puts considerably less strain on the neck muscles of the mask wearer. At the same time there is more space available for the respiratory filter, so that the filter's height and depth can be reduced compared to conventional designs. This also leads to a reduction of the tilting moment. Further, such a respiratory filter is located outside the field of vision of the mask wearer, so that there is also an improved downward view.

The respiratory protection mask may have two or more respiratory (inhalation) filters, typically respiratory filters with the same filter characteristics. For example, a first respiratory filter may be located in the forehead area and a second and third respiratory filter may be located on the side of the wearer's head. This increases the space available for the respiratory filter, further improving the weight distribution of the mask.

Further, the respiratory filter(s) may include a UV-light source, typically a UVC-light source, in particular one or more respective UV-LEDs, for example GaN-based or AlN-based LEDs, such as AlGaN LEDs, or MgZnO LEDs (as UVC-light source).

The respiratory filter(s) may even be implemented as UV-filter, in particular as UV-C filter. Accordingly, the inhalation resistance (air resistance) can be extremely low, even almost not perceivable.

Note that UV light can efficiently kill or at least inactivate bacteria and viruses. Thus, a respiratory protection mask with a respiratory filter implemented as UV-filter may be sufficient to protect the wearer against airborne germs, and thus interesting for many applications. Although an electrical power supply is then required, no filter material needs to be changed. Further, LEDs are comparatively energy efficient. Accordingly, only a comparatively small and lightweight internal electrical power supply may be used.

Note further that UVC light has, due to its lower wave length (200-280 nm), a lower depth of penetration into biological material such as skin and cornea and is thus at least less damaging compared to UVB (and UVA) light, but is nevertheless very effective at killing (the small) viruses and bacteria due to the high photon energy.

Typically, UV light sources with a wavelength spectrum such that practically no ozone is generated when the inhaled air is irradiated (wavelengths >240 nm, especially >=250 nm) may be used. Accordingly, release of (smellable) ozone from the respiratory filter can be avoided.

Typically, the UV light source(s) emit radiation with a wave length in a range from 242 nm-300 nm, more typically in a range from 250 nm-280 nm, for example about 275 nm.

However, UVB or UVA light sources may also be used. In these embodiments, the respiratory filter typically comprises or is implemented as a light labyrinth to protect the wearer.

In addition, a further respiratory filter may be arranged in, on and/or at the lower portion for filtering an exhaled airflow.

The further respiratory filter may have a different form but may be functionally implemented as described above for the respiratory filter.

Accordingly, other people may be protected against germs exhaled by the mask wearer. Thus, spreading of airborne (aerogenic) germs may be substantially reduced or even avoided.

For example, the further respiratory filter may include a further filter material such as an FFP2 or FFP3 material and/or a further light source, or may be implemented as a further UV-filter, e.g. a further UVC-filter.

The respiratory protection mask may be a passive mask without active elements facilitating the airflow such as pumps.

The respiratory protection mask may not even have an internal (electrical) power supply.

Alternatively, the respiratory filter and/or the further respiratory filter may include a respective fan. Accordingly, the breathing resistance may be reduced, and thus the wearing comfort be increased.

The further respiratory filter and/or the further fan may be arranged next to a chin of the mask wearer when the respiratory protection mask is worn.

In addition, the respiratory protection mask may include a detector for airborne particles such as viruses and bacteria, an air flow meter, a time of use detector, time of use indicator, and/or a control unit connected with any of the aforementioned components.

Accordingly, active parts such as light sources and the fan may only be activated when desired. Further, the wearer may be informed about the state of the respiratory filter(s).

Furthermore, the respiratory protection mask may have an exhalation valve. The exhalation valve is typically located in, on and/or at the lower portion, more typically completely below the mouth of a mask wearer when the mask is worn. In this way, the favorable weight distribution is further enhanced by the fact that the exhalation valve also applies substantially no additional tilting moment. At the same time, the mask wearer's mouth is not covered (visible for other persons).

Typically, the exhalation valve is located completely in front of the chin of the mask wearer when the mask is on. In this way the favorable weight distribution is maintained and at the same time the mouth of the mask wearer is not covered.

Further, a speech diaphragm or speech membrane may be arranged in, on, and/or at the lower portion, in particular in the area of the exhalation valve. This improves communication, may be interesting for schools and major events like demonstrations and sport events and/or may facilitate concerts as well as choir rehearsal in a pandemic situation or other situations hazardous to health.

Alternatively or even in addition, a microphone, typically a wireless microphone such as a Bluetooth microphone, may be arranged in, on, and/or at the lower portion, for example in an upper lateral part of the lower portion.

The respiratory protection mask typically includes a (viewing) window or visor at least substantially forming a front side of the protection mask. This leads to a significantly improved communication between the mask wearer and other persons. This may be of particular importance for communication between medical stuff and patients as well as for communication with elderly persons and/or impaired people, in particular hearing-impaired people.

The window may be arranged in the upper portion and the lower portion, and/or extend from an eye region of the mask wearer over a mouth region of the mask wearer so that the mouth of the mask wearer is visible when the respiratory protection mask is worn, typically a respective one-piece window.

Typically, a respiratory filter and an exhalation valve are arranged in the respiratory protection mask in such a way that the face of the mask wearer is substantially visible from the outside through the window/visor.

Furthermore, the respiratory protection mask typically includes a chamber separation (chamber partition) which, when in place, divides an interior space of the mask into an eye space/compartment and an oral cavity/compartment.

The chamber partition may be formed so as to extend substantially horizontally between a visor or viewing window of the respiratory protection mask and the face of the wearer but also substantially V-shaped.

In this way, on the one hand the dead space is reduced, but on the other hand the mouth of the wearer remains visible. Furthermore, such a horizontal or V-shaped chamber separation causes only a slight deflection of the breathing airflow, so that the inhalation resistance is reduced compared to a conventional airflow.

The chamber separation may also be considered as a separation or border between the upper portion and the lower portion.

Further, the chamber separation may have at least one inhalation valve, but typically two or more inhalation valves.

Typically, the chamber separation is transparent. In this way, the downward visibility of the wearer is improved.

Further, a support for a pair of spectacles may be arranged in the upper portion and/or above the chamber separation.

The respiratory masks as described herein are typically designed as full-face masks.

The respirator may have a frame which is accommodated in a flexible sealing lip. The frame gives the mask appropriate stiffness and strength. The frame can also be used, for example, to attach the visor (window) and/or the chamber separation and/or the mask strap.

Typically, the frame has a holder and/or provides a receptacle for one or more respiratory filters.

The respiratory filter(s) may be fixed in the holder or receptacle by means of locking lugs. In this way a firm fit of the respiratory filter is guaranteed.

The sealing lip may have filter sealing lips. In particular, the sealing lip or the filter sealing lips may surround the filter holder in the frame and thus provide a seal against the ambient atmosphere.

According to an embodiment, a respiratory protection mask comprises a viewing window which at least substantially forms a front side of the protection mask, and/or, when the respiratory protection mask is on, extends from an eye area of the mask wearer over the mouth area of the mask wearer so that the mouth is visible. In contrast to conventional breathing masks, in which the inner mask covers the mouth of the mask wearer, the mouth is visible in the solution described herein.

According to an embodiment, a respiratory protection mask comprises a respiratory filter, wherein the mask is designed in such a way that the respiratory filter is arranged substantially above nostrils of a mask wearer when the respiratory protection mask is worn.

Those skilled in the art will recognize additional features and advantages upon reading the following detailed description, and upon viewing the accompanying drawings.

### BRIEF DESCRIPTION OF THE DRAWINGS

The enclosed drawings illustrate embodiments and serve together with the description to explain the principles of the invention. The components in the Figures are not necessarily to scale, instead emphasis is placed upon the principles illustrated therein.

FIG. 1 shows a schematic sectional view of a conventional respirator in which the airway is shown.

FIG. 2 shows a schematic sectional view of a respiratory protection mask and the airway according to an embodiment.

FIG. 3 shows a perspective view of a respiratory protection mask and the airway according to an embodiment.

FIG. 4 shows a perspective view of a respiratory protection mask according to an embodiment.

FIG. 5 shows an exploded view of a respiratory protection mask according to an embodiment.

FIG. 6 shows a detailed view of the forehead area of a respiratory protection mask according to an embodiment.

FIG. 7 shows a further detailed view of the forehead area of a respiratory protection mask according to an embodiment.

FIG. 8 shows a side view of a respiratory protection mask according to an embodiment.

FIG. 9 shows a top view of a respiratory protection mask according to an embodiment.

FIGS. 10A to 10D show perspective views of a respiratory filter of the respiratory protection mask illustrated in FIG. 9 according to an embodiment.

FIG. 11 shows a top view of a respiratory protection mask according to an embodiment.

FIG. 12 shows a top view of a respiratory protection mask.

FIG. 13 shows an exploded view of a respiratory protection mask according to an embodiment.

FIG. 14 shows an exploded view of a respiratory protection mask according to an embodiment.

FIG. 15 shows a perspective view of a respiratory protection mask according to an embodiment.

FIG. 16 shows a sectional view of a respiratory protection mask and the airway according to an embodiment.

FIG. 17 shows a sectional view of a respiratory protection mask and the airway.

FIG. 18 shows an exploded view of a respiratory protection mask according to an embodiment.

FIGS. 19A to 19C show sectional views of a respiratory protection mask according to an embodiment.

FIGS. 20A to 20D show views of a respiratory filter according to an embodiment.

FIGS. 21A to 21D show views of a respiratory filter according to an embodiment.

FIGS. 22A and 22B show views of a respiratory filter according to an embodiment.

FIGS. 23A and 23B show sectional views of a respiratory protection mask according to an embodiment.

FIGS. 24A to 24C show perspective views of a respiratory filter according to an embodiment.

### DETAILED DESCRIPTION

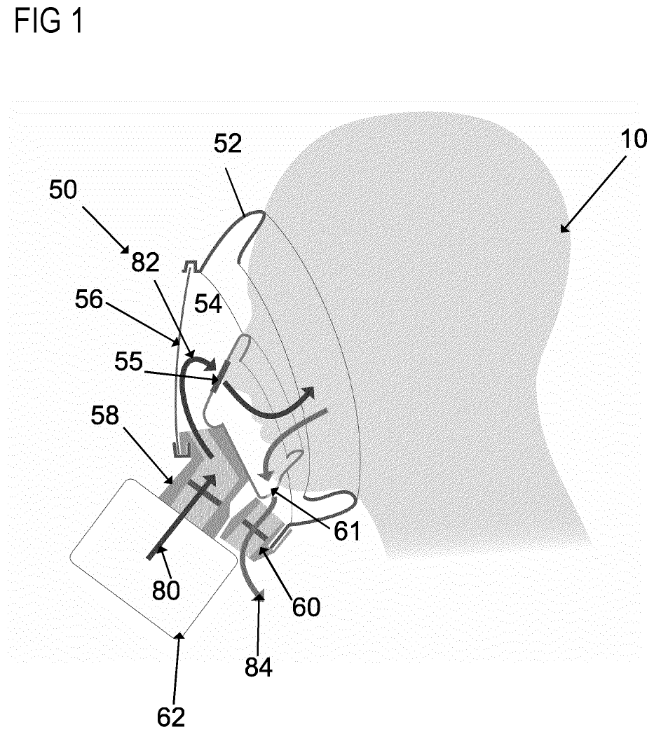

FIG. 1 shows a schematic sectional view of a conventional respirator 50. The conventional respirator 50 is designed as a full-face mask and has a sealing lip 52 that seals the face of the wearer 10 from the ambient atmosphere. The mask 50 also has an inner mask 54 which accommodates the mouth and nostrils of the mask wearer 10. An inhalation valve 55 is located in the inner mask 10. The mask 50 also has a transparent viewing window 56. A connection 58 for a respiratory filter 62 is located at the front of the mask. Typically, connection 58 has an internal thread and respiratory filter 62 has an external thread for connection to connection 58. Finally, mask 50 has an exhalation valve 60, through which the exhaled air can leave mask 50. The exhalation valve 60 in mask 50 can be assigned a corresponding exhalation valve 61 in the inner mask.

Furthermore, arrows 80, 82 of FIG. 1 illustrate the path of the inhalation airflow. Here it becomes clear that in the area 82 a strong deflection of the breathing air by approx. 180° takes place. In other words, the flow direction of the breathing air is essentially reversed here. If the wearer 10 breathes in through the nose, the direction of flow is reversed again immediately afterwards. This leads to a not negligible breathing resistance of the conventional respiratory protection mask 50.

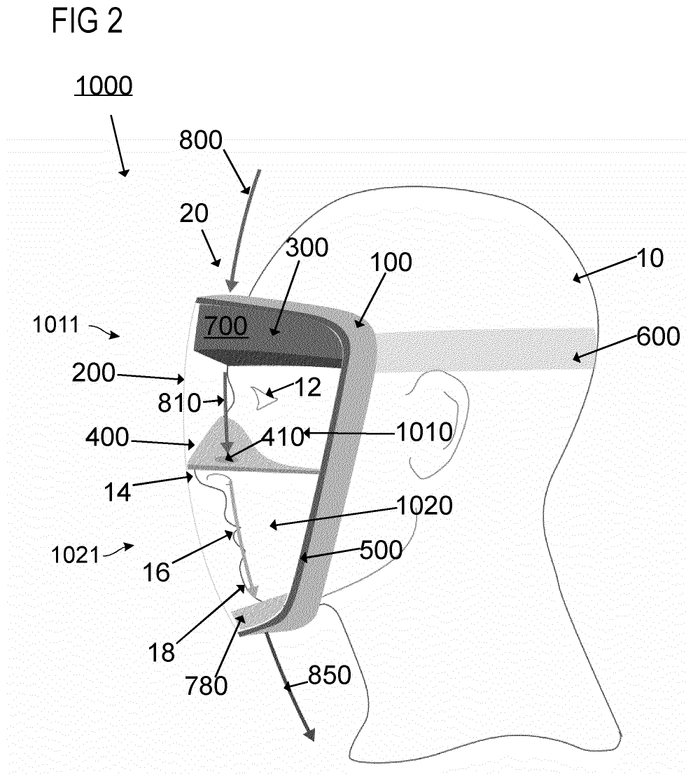

FIG. 2 shows a schematic sectional view of a respiratory protection mask 1000 having with respect to the airflow indicated by arrows 800, 810, 850 an upper portion 1011 and a lower portion 1021. In the exemplary embodiment, the respiratory protection mask 1000 is also designed as a full-face mask and has a sealing lip 100 which seals the face of the mask wearer from the ambient atmosphere. The sealing lip 100 is typically made of a flexible and/or soft material to ensure a good fit and seal.

The respiratory protection mask 1000 is held on the head of the wearer by a strap 600. The mask strap 600 can be made in one piece with the sealing lip 100 or as a separate part. The mask strap 600 may also be implemented as a spider.

At the front, the exemplary mask 1000 has a transparent or semi-transparent viewing window 200 extending from an eye region of the mask wearer over a mouth region of the mask wearer. Furthermore, a frame 300 is provided, which gives the mask 1000 strength.

Typically, window 200 is attached to the frame 300, in particular in an airtight manner, e.g. using a respective gasket.

Mask 1000 has an optional chamber separation 400, which separates the interior of the mask into an eye compartment 1010 and a mouth compartment 1020. The chamber separation 400 is typically also made of a flexible and/or soft material to ensure good fit and thus a tight seal between the two chambers.

As mentioned above, a chamber separation reduces the dead space and also prevents fogging of the viewing window 200 in the area of the eyes 12. If this is not required and/or if the viewing window is suitably coated the chamber separation can also be dispensed with. The exemplary chamber separation 400 has two inhalation valves 410, through which the inhaled (breathing) air can enter from the eye compartment 1010 into the mouth compartment 1020. Furthermore, the chamber separation 400 typically has an impression 420 on the nose of the wearer. This impression may be individualized on a wearer or may be designed in one or more general fits.

Alternatively or in addition, a protective coating, in particular an anti-fog coating at a head-facing side of the viewing window may be provided.

In the exemplary embodiment, chamber separation 400 is except for impression 420 substantially flat (horizontally orientated).

Further, the chamber separation may be substantially V-shaped, more particular at least substantially shaped like an inverted V in frontal view. Accordingly, the inner volume of the lower portion (oral cavity) 1021 can be kept very small. For example, the chamber separation may, except for a central nose portion, be shaped like an inverted V in frontal view.

The exemplary respiratory protection mask 1000 also includes a respiratory filter 700, which is located in upper portion 1011, more particular in the forehead area 20 of the mask wearer. Through this arrangement of the respiratory filter 700, an inhalation airflow 800, 810, represented by arrows, runs in a substantially straight line from the respiratory filter 700 to the nose 14 of the mask wearer 10 when the respiratory protection mask 1000 is worn. In this way the inhalation resistance of the mask 1000 can be significantly reduced compared with the conventional airflow 80, 82 in a conventional respiratory protection mask 50 illustrated in FIG. 1. Since respiratory protection masks are often worn in hazardous situations and/or during physical exertion, the wearer is less fatigued when wearing mask 1000.

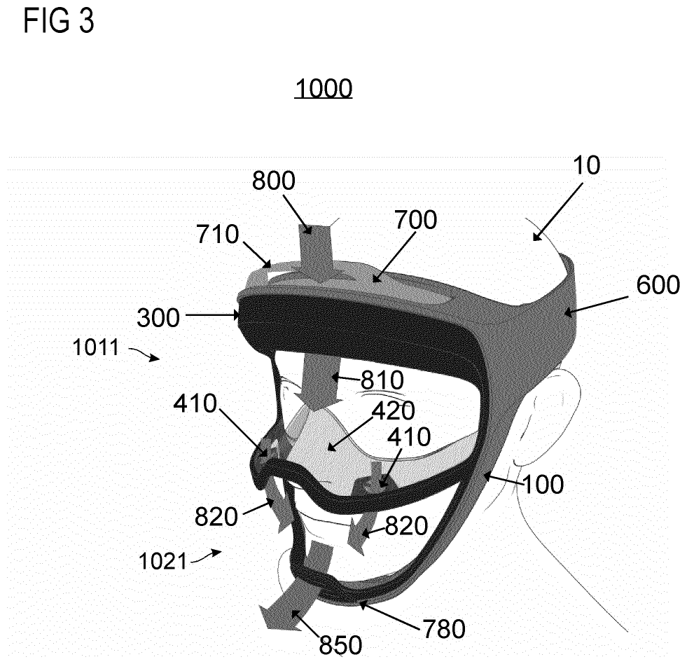

This is also illustrated in FIG. 3 showing a perspective view of the respiratory protection mask 1000. The ambient air 800 is drawn into the eye area of mask 1000 via respiratory filter 700 located in the forehead area of the wearer 10, as illustrated by arrow 810. The flow path now continues via the two inhalation valves 410 located in the chamber separation 400 into the mouth compartment and oral cavity, respectively, as illustrated by the two arrows 820. The exhalation airflow then leaves mask 1000 starting from the mouth or nose of the wearer via an exhalation valve 780 arranged in lower portion 1021, more particular the lowermost part of mask 1000.

As shown in FIG. 3, the inhalation airflow runs substantially vertically within mask 1000. The inhalation airflow is only slightly deflected on its way from respiratory filter 700 to the nose of a mask wearer. Typically, the airflow inside the mask is deflected by less than 90°, or less than 60 or even less than 45°. Any diversion of the inhalation flow increases the inhalation resistance in the mask, although the resistance also depends on the strength of the airflow. In particular, 180° deflections (reversal of flow direction) increasing the inhalation resistance enormously may be avoided. The airflow described above can therefore result in a (more) pleasant breathing resistance.

In this context, the positioning of the inhalation valve(s) 410 is also referred to. In the exemplary embodiment, one inhalation valve 410 is arranged on each side of the nose. This results in a division of the airflow, whereby both parts are led laterally past the nose. However, other arrangements of the inhalation valve or the inhalation valves 410 are also conceivable. For example, the inhalation valve could be arranged as a single valve centered in molded portion 420. The number and arrangement of the inhalation valves 410 may be selected according to the desired airway.

Furthermore, FIG. 3 shows that the chamber separation 400 is typically made of a transparent material. In this way the chamber separation 400 does not cover the field of vision directly downwards.

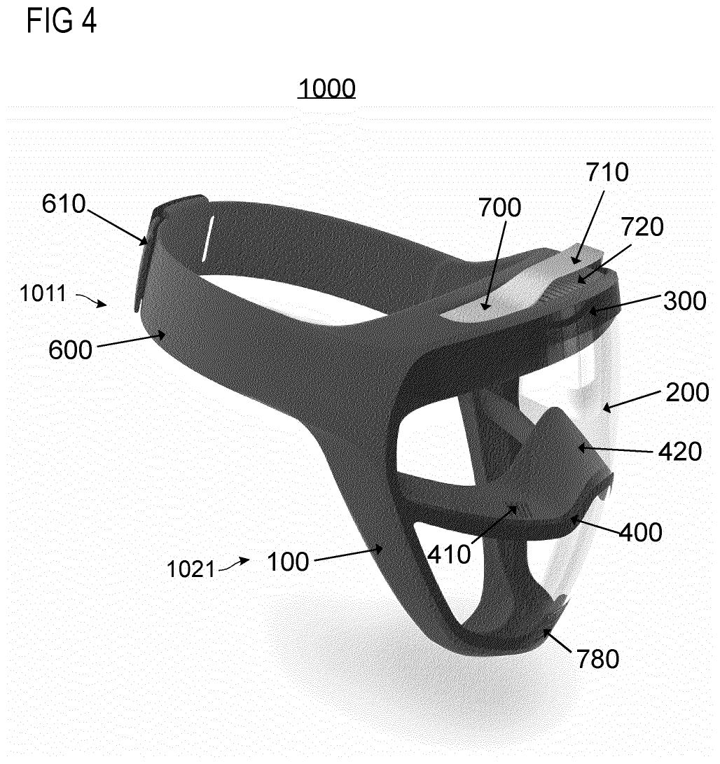

FIG. 4 shows a perspective view of the respiratory protection mask 1000. As shown, sealing lip 100 and mask strap 600 may be made in one piece. Further, mask strap 600 may have an adjuster 610 which can be used to adjust mask 1000 so that it fits snugly against the wearer's head. FIG. 4 also shows the optional air inlet slits 720 in the respiratory filter 700. Further, respiratory filter 700 may have a handle 710 which allows respiratory filter 700 to be changed quickly and easily.

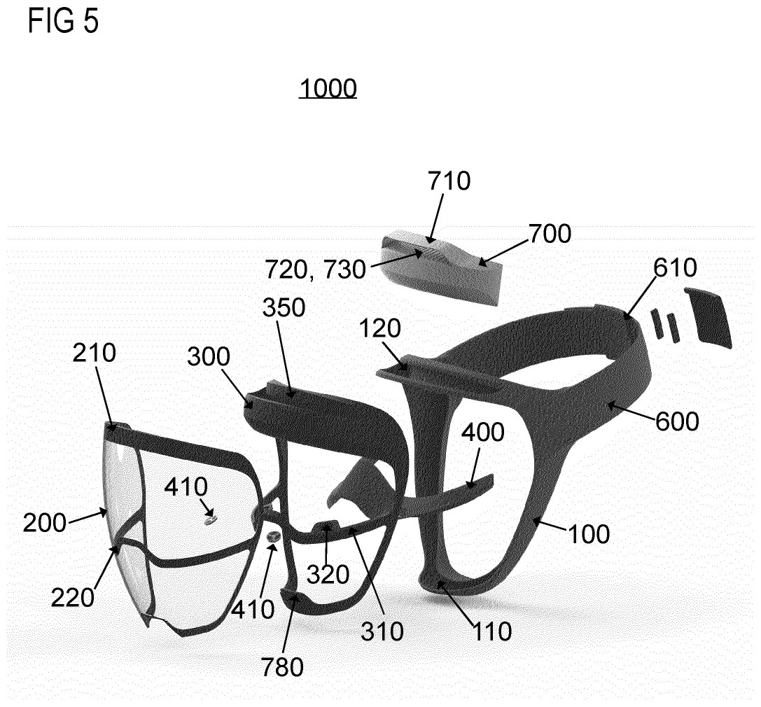

FIG. 5 shows an exploded view of the respiratory protection mask 1000 including a sealing lip 100 having a circumferential receptacle 110 for a rigid frame 300. The exemplary sealing lip 100 also has an opening 120 for the respiratory filter 700. In the exemplary embodiment, the sealing lip 100 is formed in one piece with the mask strap 600.

Further, rigid frame 300 is provided as a basic support for the respiratory protection mask 1000. The frame 300 can be inserted into receptacle 110 of sealing lip 100 so that it is at least partially enclosed by the sealing lip 100. Sealing lip 100 is used to provide a seal between the face of a mask wearer and frame 300. The frame 300 has a web (nose-piece) 310 in the area of the nose, which can serve, among other things, as a support for the chamber separation 400. The exemplary web 310 has two receptacles 320 for the inhalation valves 410. If the inhalation valves 410 are inserted in the receptacles 320, the flexible chamber separator 400 can be placed on the web 310 and, for example, attached to it. The chamber separation 400 typically has openings or air slits corresponding to the inhalation valves 410.

The frame 300 may have/provide a filter holder 350 providing a receptacle for the respiratory filter 700. The filter holder 350 is located in the front area of frame 300. If the frame 300 is inserted in receptacle 110 of sealing lip 300, the opening of the filter holder 350 pointing upwards corresponds with the opening 120 of the sealing lip in this area. The shape and size of the two corresponding openings may be selected so that the respiratory filter 700 can be inserted through the opening 120 into the filter holder 350. The respiratory filter 700 may be held in the receptacle 350 by means of catches, springs or the like. In particular, respective positive and/or non-positive connecting elements may be provided for this purpose. Further, an exhalation valve 780 may be provided in the chin area of frame 300. Even further, a speech diaphragm may also be provided in the area of the exhalation valve 780 for improving understanding.

The respiratory protection mask 1000 has a viewing window 200 made in one piece and typically shaped/implemented as a visor. As shown, viewing window 200 may have an integral mounting frame 210, 220. With the mounting frame 210, 220, the window 200 can be fixed at and/or close to frame 300.

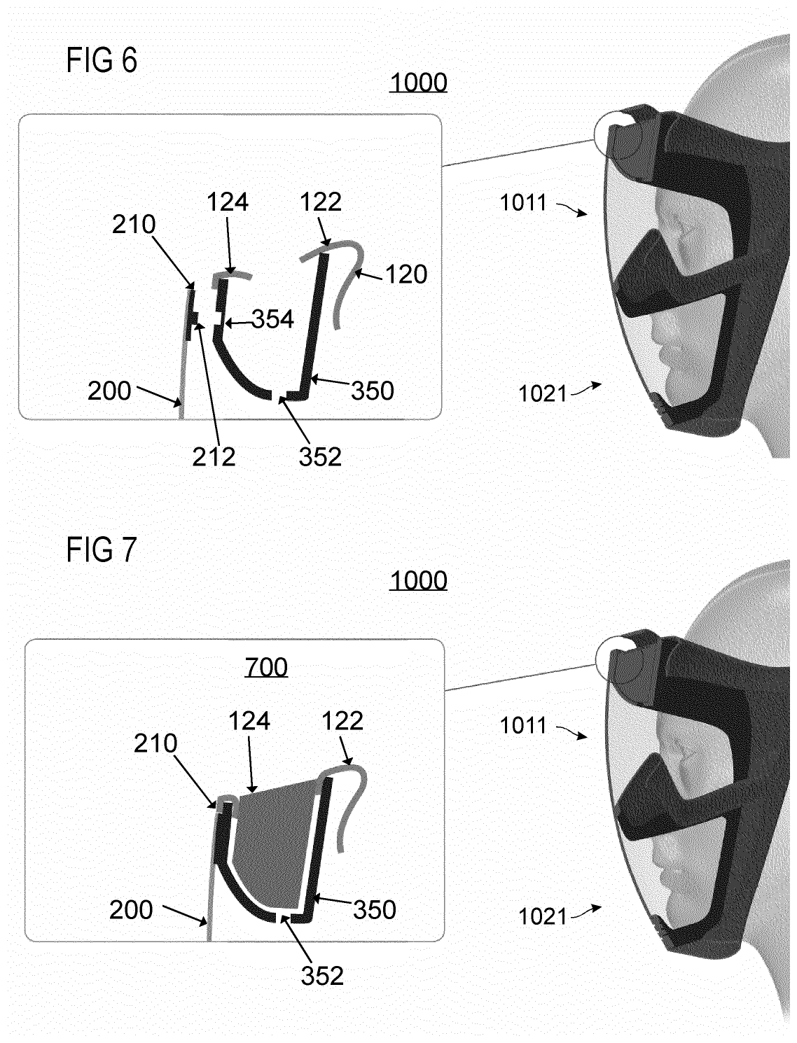

Referring to FIG. 6 and FIG. 7 details are explained on how to attach the viewing window 200 to the frame 300 and how to insert the respiratory filter 700 into the filter holder 350. FIG. 6 and FIG. 7 show respective detailed cross-sectional views of the forehead area of the respiratory protection mask 100.

As shown in the enlarged view of FIG. 6, the fastening frame 210 of the viewing window 200 may have a lug 212 or a spring. As a counterpart to this, frame 300 has a groove 354 into which the lug 212 can be inserted. The lug 212 can be glued or welded in the groove 354 or otherwise be connected to the frame 300 in a sealing manner. FIG. 7 shows the connection of window 200 and frame 300 created by inserting the lug 212 into the groove 354. The lug 212 can be formed all around the fastening frame 210. The groove 354 can also be formed all around the frame 300, so that a circumferential tight connection between window 200 and frame 300 can be formed. Furthermore, web 310 can also have a groove into which a lug formed in the fastening frame 220 can be inserted. In this way a good seal can be provided by the chamber separation 400 between upper portion 1011 and lower portion 1021 (between the eye area and the mouth area/compartments) of mask 1000.

Furthermore, the exemplary filter holder 350 shown in FIG. 6 has an air passage 352 at its lower end forming the air outlet of respiratory filter 700. Through the air passage 352 the air cleaned by the respiratory filter 700 enters the eye area of mask 1000 from above.

Also shown in FIG. 6 are filter sealing lips 122, 124 of sealing lip 100. The exemplary filter sealing lips 122, 124 completely surround the opening 120 of sealing lip 100 and serve to create a seal when the respiratory filter 700 is inserted as shown in FIG. 7.

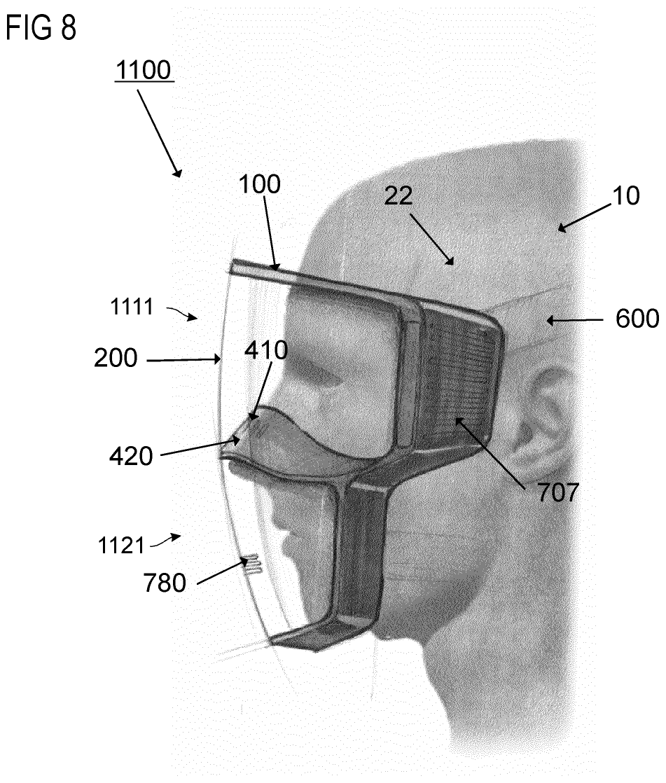

FIG. 8 shows a side view of a respiratory protection mask 1100. Different to respiratory protection mask 1000 explained above with regard to FIG. 2 to FIG. 7, the respiratory filter 707 of mask 1100 is located on the side of the head of the mask wearer 10, namely approximately in the temple region 22. A further respiratory filter arranged on the other side of the head is not shown in FIG. 8. Respiratory filter 707 and the further respiratory filter may be implemented and/or be arranged at least substantially mirror symmetric with respect to a central virtual vertical plane of mask 1100. Due to arranging the respiratory filter(s) 707 at the side, the respiratory filter(s) is/are moved completely out of the field of vision of the mask wearer. Furthermore, the weight of the respiratory filter(s) on the head is shifted backwards, which results in a much better weight distribution than with conventional masks. In particular, such a weight distribution reduces a possible tilting moment, and thus an effort of the neck muscles. Furthermore, the arrangement of the respiratory filter 707 shown in FIG. 8 may also improve the airflow in the mask. The other components may be very similar to the corresponding components of mask 1000.

Furthermore, the embodiments explained herein with respect to the arrangement of the respiratory filter in the forehead area and with respect to the arrangement of the respiratory filters at the side of the head may be combined with each other, so that a respiratory protection mask is provided in which the respiratory filter or filters are arranged both in the forehead area and at the side of the head of the wearer.

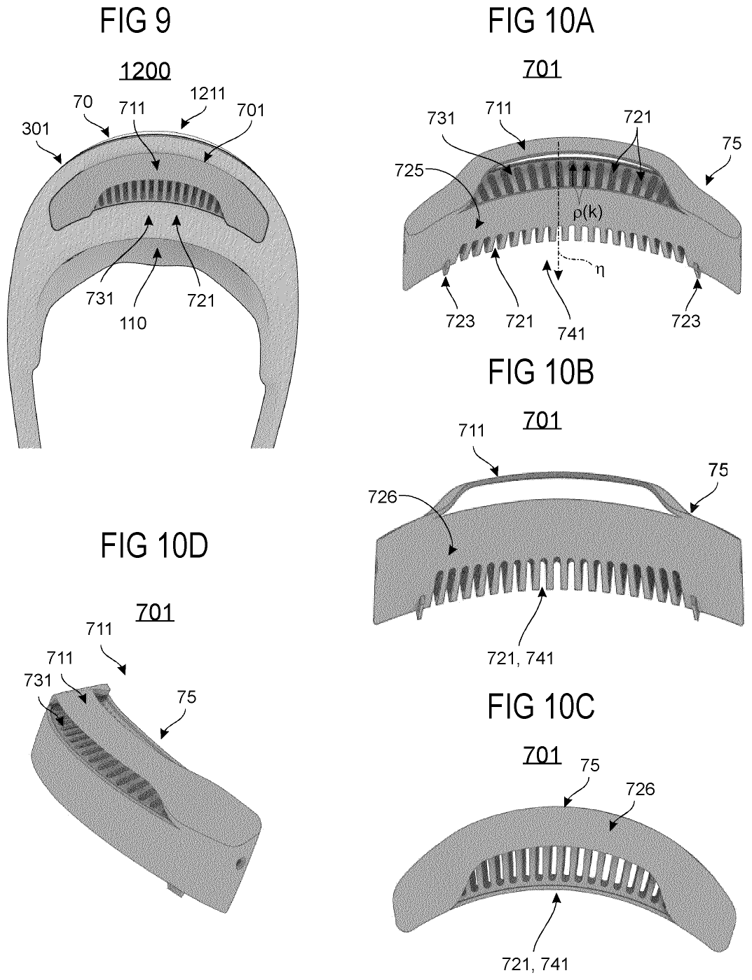

FIG. 9 shows a top view of a respiratory protection mask 1200. Mask 1200 is typically similar to mask 1100 explained above with regard to FIG. 2 to FIG. 7.

In the exemplary embodiment, mask 1200 has a mask body 70 and a respiratory filter 701 having a handle 711 and a plurality of air slits 721 extending from an air inlet 731 to an air outlet 741 (not visible in FIG. 9 but in FIGS. 10A-10C), and inserted in to a receptacle provided by an upper portion 1211 of mask body 70 and mask 1200, respectively. Mask body 70 may include a frame 301, a holder 710 for the frame 301, a mask strap and sealings similar as explained above with regard to FIG. 2 to FIG. 7. For sake of clarity a typically present window/visor of mask 1200 is not shown in FIG. 9.

As shown in FIGS. 10A to 10D illustrating different perspective views of respiratory filter 701, handle 711 may be attached to lateral sides of a substantially sickle-shaped respiratory filter housing 75 having a curved forehead-facing side 725 and a curved frontal side 726 arranged opposite the forehead-facing side 725.

In the exemplary embodiment, filter housing 75 is substantially sickle-shaped when seen from above and in a cross-section perpendicular to a direction η of the inhaled airflow, respectively, typically in the majority or even all cross-sections which are perpendicular to direction η, and cut/intersect both sides 725, 726.

Further, air slits 721 extend in direction η of the inhaled airflow between air inlet 731 to an air outlet 741, and substantially between forehead-facing side 725 and frontal side 726.

The curvatures of forehead-facing side 725 and frontal side 726 may be chosen in accordance with an expected (medium) curvature of a forehead of an intended wearer and/or depend on a size of respiratory filter housing 75.

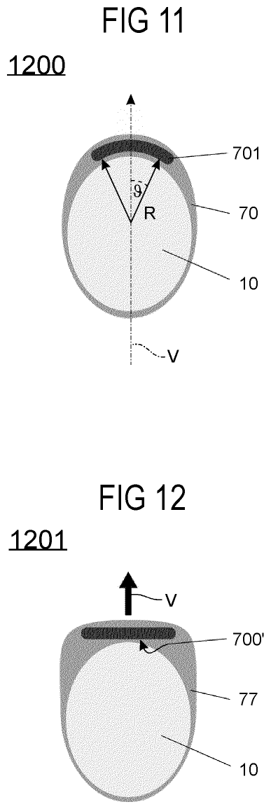

This is further illustrated in FIG. 11 representing a top view on respiratory protection mask 1200 and a cross-section perpendicular to direction η (and/or parallel to a viewing direction V) through respiratory protection mask 1200, respectively.

The radius of curvature R of the forehead-facing side 725 may be at least sufficiently constant in the illustrated cross-section(s), at least in a central portion, and/or be in a range from about 9 cm to about 90 cm, more typically in a range from about 10 cm to about 80 cm, and even more typically in a range from about 10 cm to about 30 cm.

However, the radius of curvature R may also slightly vary, e.g. decrease by a few percent with increasing angle ϑ to a central (vertical) plane and the viewing direction V, respectively (R=R(ϑ)).

Further, the curvature of frontal side 726 is typically larger than the curvatures of forehead-facing side 725, for example by a few percent to about 10%.

Due to the curvatures of forehead-facing side 725 and frontal side 726 neighboring slits 721 are typically tilted with respect to each other in the cross-section(s) perpendicular to direction η. This is indicated in FIG. 10A by the two arrows ρ(k) where k is an index of the slits 721.

Using a finite radius of curvature R of the forehead-facing side 725 (and of the frontal side 726) results, compared to a similar respiratory filter 707 but with infinite radius of curvature of the forehead-facing side as shown in FIG. 12, to a lower air resistivity.

As further illustrated in FIG. 10A, respiratory filter 701 may have in the lateral portions a respective guide element 723 fitting with a counterpart provided by the main body 70 and the receptacle thereof, respectively.

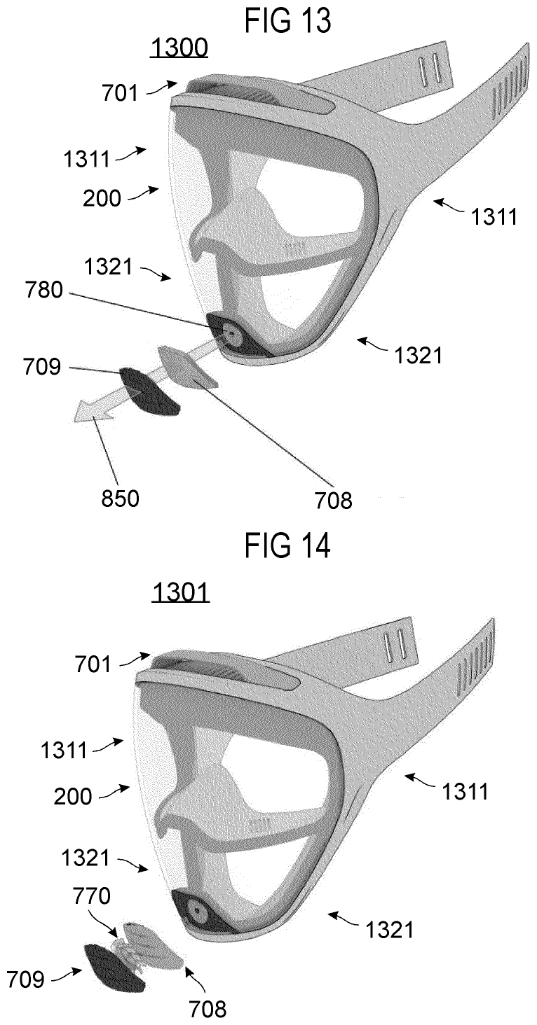

FIG. 13 shows an exploded view of a respiratory protection mask 1300. Mask 1300 is typically similar to the masks 1000-1200 explained above with regard to FIG. 2 to FIG. 9 and has, in the exemplary embodiment, a respiratory filter 701 as explained above with regard to FIG. 10A to FIG. 10D.

Mask 1300 is also provided with an exhalation valve 780 in the chin region for improving understanding and/or reducing exhalation resistance.

In addition, a further respiratory filter 708 is arranged in the exhaled airflow 850 and fixed on exhalation valve 780 using a fixing clip 709.

In the exemplary embodiment, the further respiratory filter 708 is implemented as a filter mat, e.g. an activated charcoal, FFP2 or FFP3 filter mat or any combination thereof.

However, the further respiratory filter 708 may also include a UV-light source or be implemented as UV-filter.

FIG. 14 shows a perspective view of a respiratory protection mask 1301. Mask 1301 is typically similar to masks 1300 explained above with regard to FIG. 13, but has in addition a fan 770 arranged in a lowermost part of lower portion 1321 and the chin region, respectively, and on the further respiratory filter 708 (more particular between filter mat 708 and clip 709 in the exemplary embodiment) for further facilitating exhaling.

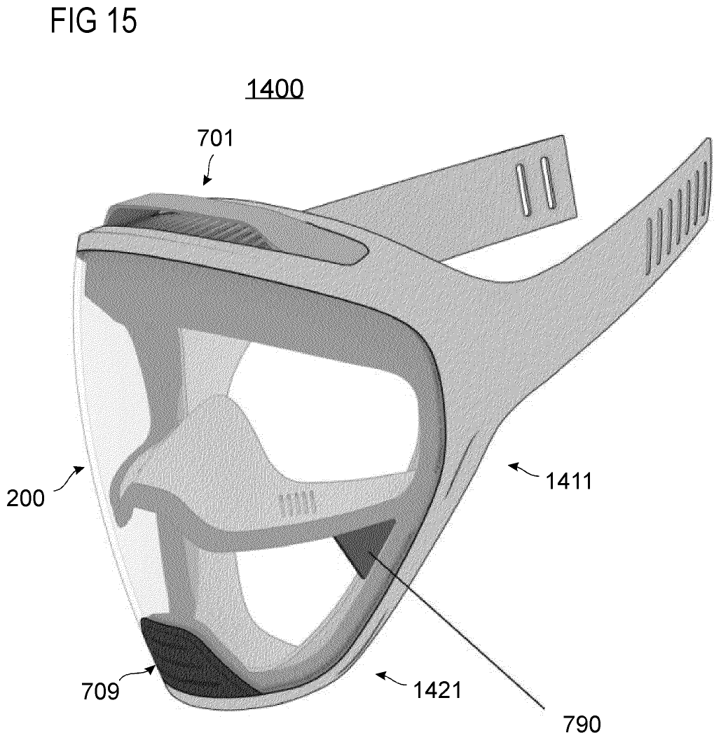

FIG. 15 shows a perspective view of a respiratory protection mask 1400. Mask 1400 is typically similar to masks 1300 and 1301 explained above with regard to FIGS. 13 and 14. In addition, a wireless microphone 790 is arranged in an upper lateral part of lower portion 1421 to facilitate wireless communication, for example with a smartphone or a computer.

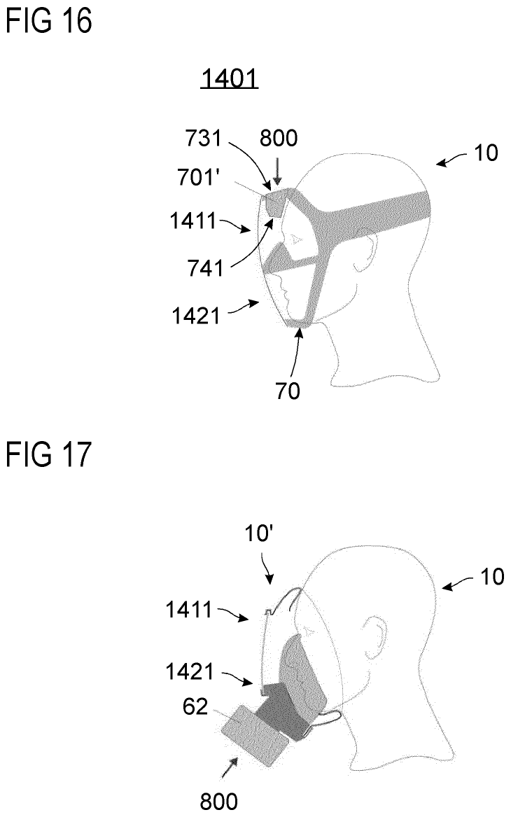

FIG. 16 shows a side view of a respiratory protection mask 1401. Mask 1401 is typically similar to the masks 1000 to 1301 explained above with regard to FIGS. 2 to 15. However, the respiratory filter 701′ of mask 1401 is integrated in upper portion 1411, more particular in an uppermost (central) part of upper portion 1411, wherein the air inlet 731 of filter 701′ is (approximately) flush with mask body 70.

For comparison, a side view of a respiratory protection mask 50′, which is typically similar to mask 50 explained above with regard to FIG. 1, is shown in FIG. 17.

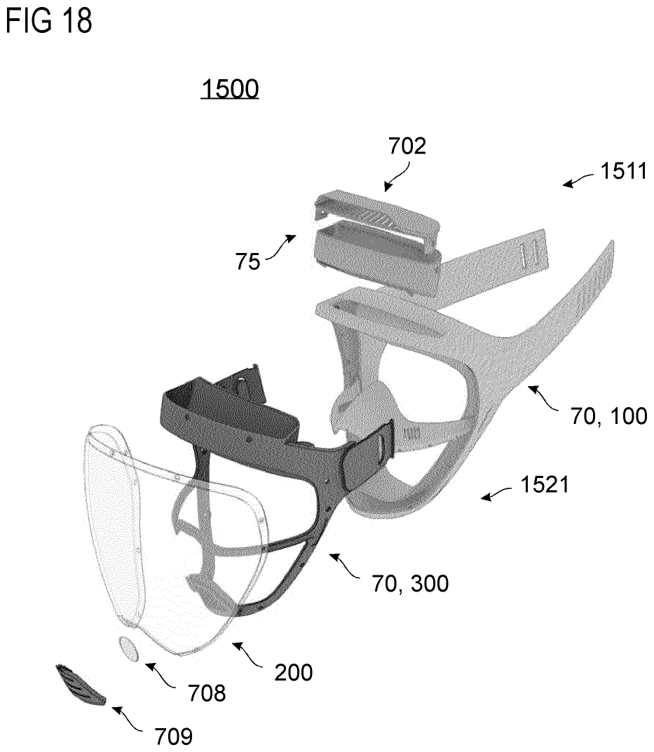

FIG. 18 shows an exploded view of a respiratory protection mask 1500. Mask 1500 is typically similar to mask 1300 explained above with regard to FIG. 13. However, the filter body 75 of respiratory filter 702 is in two parts. Accordingly, filter material(s) (not shown in FIG. 18) may be replaced easily if desired.

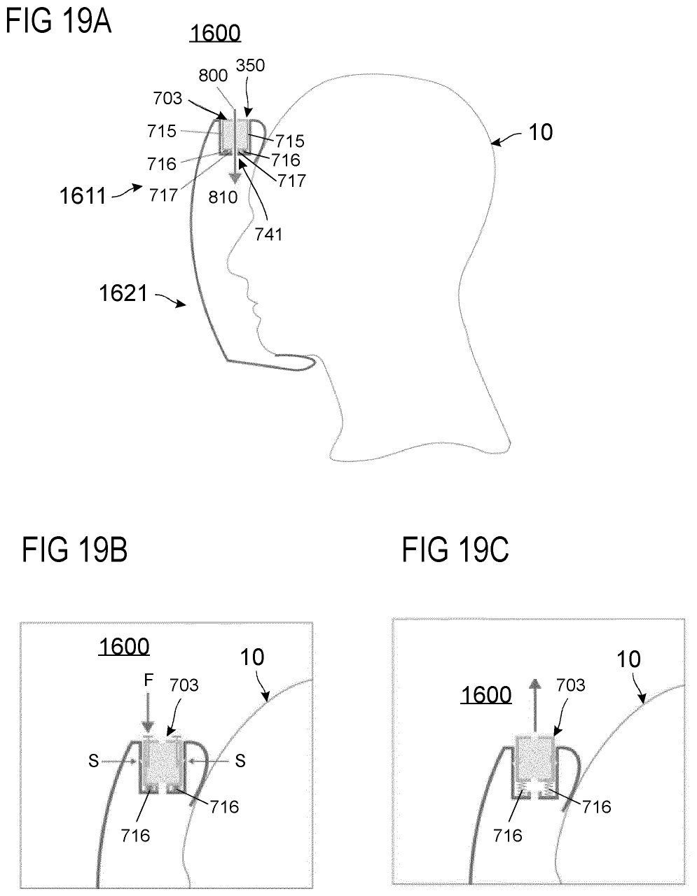

FIGS. 19A to 19C show sectional views of a respiratory protection mask 1600 which is typically similar to mask 1401 explained above with regard to FIG. 16. However, the respiratory filter 703 of mask 1600 is fixed using a snap spring filter arrangement.

More particular, a sealing 717 such as an O-ring for an air outlet 741 of filter 703 and one or more springs 716 are arranged at a bottom of a receptacle 350 for the respiratory filter 703. Further, filter 703 has on the forehead-facing side and the frontal side a respective latch nose 715 that can snap into corresponding recesses in sidewalls of receptacle 350. FIG. 19A illustrates mask 1600 with filter 703 in latched state.

Filter 703 may be released by pressing a button on filter 703 from above as illustrated by arrow F in FIG. 19B resulting in a release of the snap connection as indicated by the arrows S.

Thereafter, the releasing spring(s) 716 lifts/lift filter 703 as illustrated in FIG. 19C.

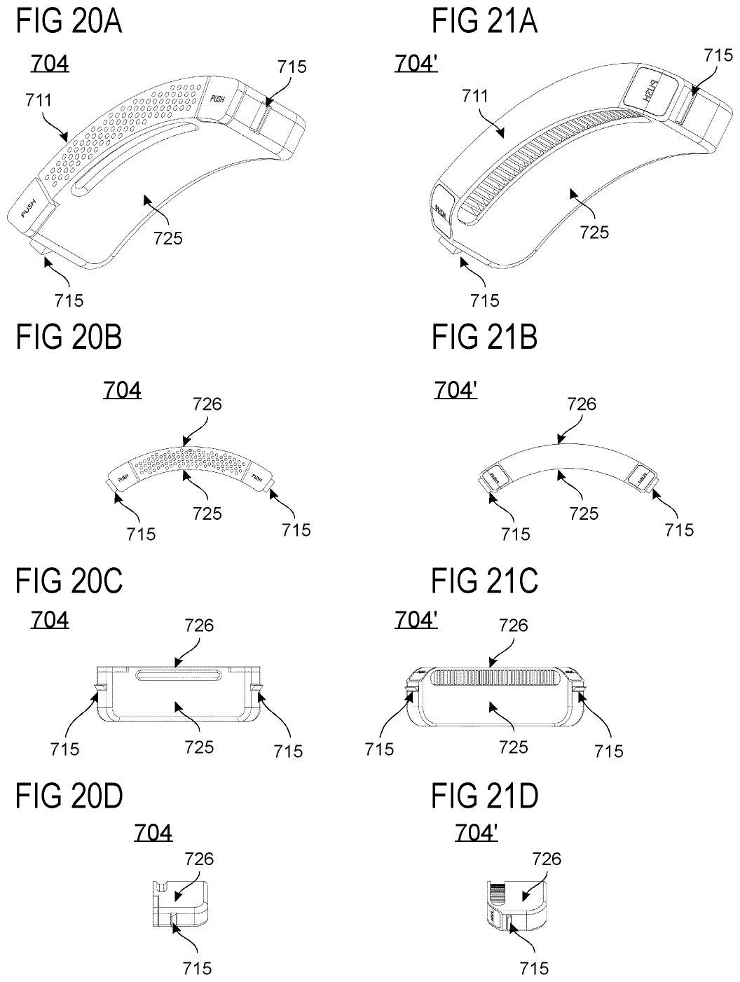

FIGS. 20A to 20D and 21A to 21D show different (corresponding) views of a respiratory filter 704 and 704′ of slightly different designs that may be used instead of respiratory filter 703 in mask 1600 explained above with regard to FIGS. 19A to 19C. Filters 704, 704′ also have two latch noses 715 and two (push) buttons for releasing a respective snap connection. In addition, filters 704, 704′ have a respective handle 711 facilitating inserting and releasing filter 704, 704′ in the mask receptacle. The handle 711 of filter 704 may be provided with through-holes to facilitate air flow.

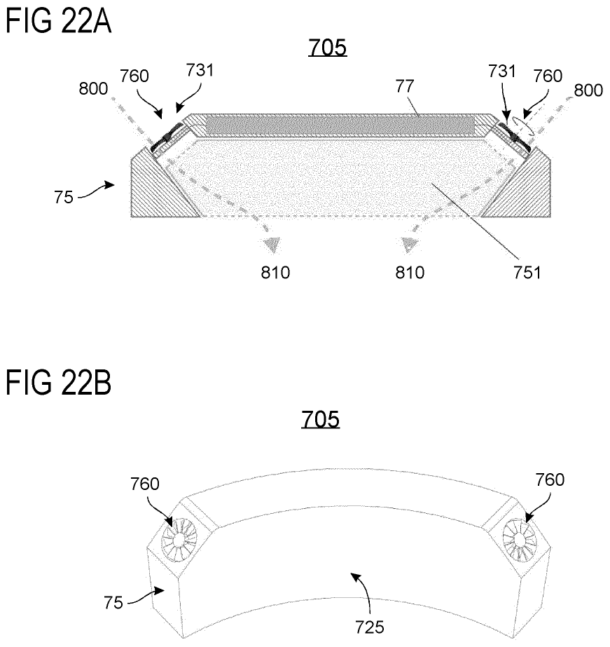

FIGS. 22A and 22B illustrate a respiratory filter 705 in a cross-sectional view and a perspective view, respectively. Respiratory filter 705 has two laterally arranged fans 760 (at respective air inlets 731) supplied by an internal batterie 77 and facilitating breathe in of ambient air 800 and filtering the air using a filter material 751.

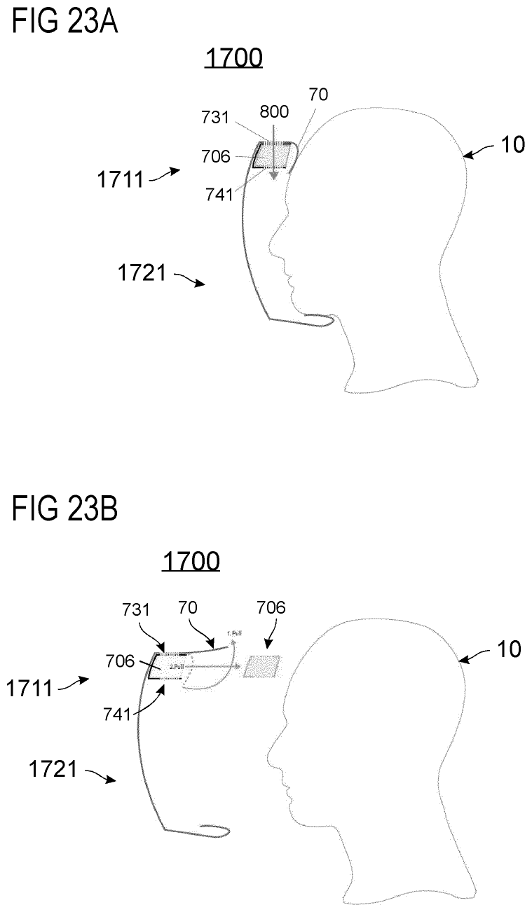

FIGS. 23A and 23B show side views of a respiratory protection mask 1700 also having a replaceable respiratory filter 706.

However, filter 706 of mask 1700 is not accidently removable (and insertable) when mask 1700 is worn as illustrated in FIG. 23A, but only when detached as illustrated in FIG. 23B by first pulling the flexible lip of mask body 70 (“1. pull”) and thereafter pulling out filter 706 from the receptacle (“2. pull”).

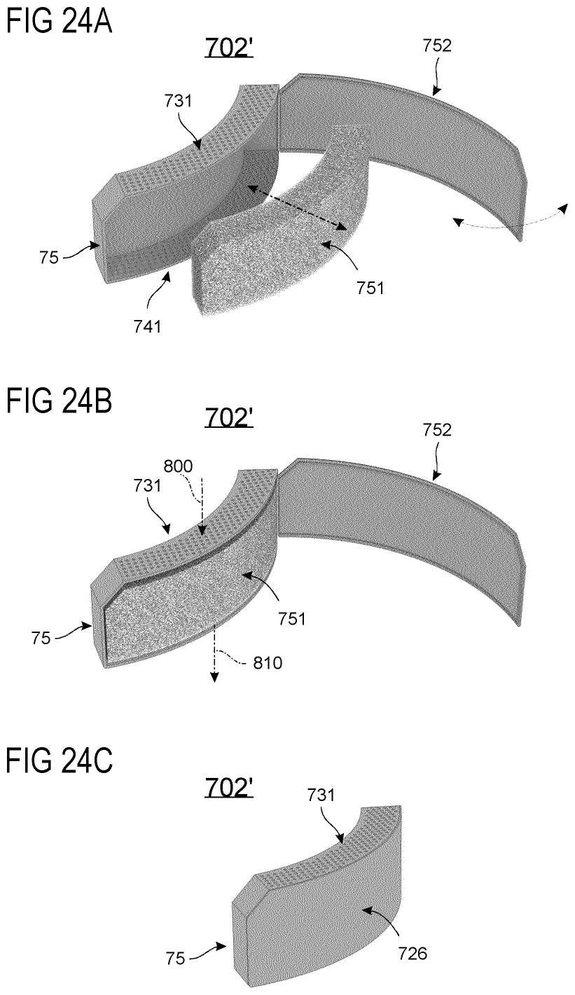

FIGS. 24A to 24C show perspective views of a respiratory filter 702′. The respiratory filter 702′ is typically similar to the inlet respiratory filters 700, 701, 702, 703, 704, 704′, 705 and 706 explained above. However and as indicated by the dashed-dotted arrows in FIG. 24A, housing 75 of filter 702′ has a hinged cover 752 allowing for inserting and removing (replacing) of a filter material 751 in an open state of housing 75 illustrated in FIGS. 24A, 24B. FIGS. 24C illustrates a closed state of filter 702′ and its housing 75, respectively. In the exemplary embodiment, filter material 751, which is implemented as a filter mat, is replaceable in a direction at least substantially perpendicular to the (intended) air flow through filter 702′.

Further, the air inlet 713 and the air outlet 741 of filter 702′ are provided by a top plate and base plate of housing 75, respectively, each having a plurality of exemplary round holes for the air flow (instead of elongated air slits in other embodiments).

All the examples of the present invention show an inhalation airflow running substantially in a straight line (at moist slightly bent) from an area above the nose of a person wearing a mask. In particular, the respiratory filter may be located wholly or partly above the nose of the wearer of the mask. In this way, an inhalation resistance of the mask can be significantly reduced compared to the conventional airflow in respiratory protection masks.

Furthermore, the arrangement of the filters results in a different weight distribution of the mask compared to conventional masks, which means that the neck muscles of the mask wearer are significantly less strained.

At the same time there is more space available for the respiratory filter, so that the height and depth of the filter can be reduced compared to conventional respiratory filters.

Finally, the respiratory filter is typically located outside the mask wearer's field of vision, so that improved visibility is also provided.

Due to a typically used viewing window that extends from the upper portion to the lower portion, at least from the eyes over the mouth of the wearer when the respiratory protection mask is on, the mouth remains visible. Compared to conventional respiratory protection masks, where the inner mask covers the wearer's mouth, this leads to significantly improved communication between the wearer and other people.

Although the present description represents and describes specific embodiments, it is within the scope of the present invention to modify the embodiments shown in a suitable manner without this leading outside the scope of protection. The following claims represent a first, non-binding attempt to define the invention in general.

### LIST OF REFERENCE SIGNS

10 Mask wearer/person
12 Eyes
14 Nose
16 mouth
18 chin
20 Front area
50 Mask
52 Sealing lip
54 Inside mask
55 Single valve
56 window
58 Connection for respiratory filter
60 Exhalation valve
61 Exhalation valve
62 Breathing filter/respiratory filter
70 mask body/main body
75 filter body/housing
80 Intake airflow
82 Rerouting
84 Exhaled airflow
100, 101 Sealing lip
110 Holder for frame
120 Holder for filter area
122 Filter sealing lip
124 Filter sealing lip
200 (viewing) window/visor
210 Fixing frame
212 Nose
220 Fixing frame
300, 301 Frame
310 web
320 Holder for inhalation valve
350 Holder, receptacle for respiratory filter
352 Air diffuser
354 Slot
400 Chamber separation
410 Single breathing valve
420 impression
600 Mask strap
610 Adjuster
700-707 (inlet) respiratory filter
708 (outlet) respiratory filter
709 fixing clip
710, 711 handle
720, 721 air slits
730, 731 air inlet
740, 741 air outlet
751 filter material, filter mat
760, 770 fan
780 Exhalation valve
790 microphone
800 sucked in air/ambient airflow
810 intake airflow/inhaled airflow/inhalation air stream
820 Intake airflow
850 Exhaled airflow
1000-1700 Respiratory protection masks
1010, 1110, 1210 eye compartment
1011, 1111, 1211 . . . 1711 upper portion
1020, 1120, 1220 mouth compartment
1021, 1121, 1221 . . . 1721 lower portion
V viewing direction

1-47. (canceled)

48. A respiratory protection mask comprising:
an upper portion;
a lower portion; and
a respiratory filter comprising an air outlet, the respiratory filter being arranged in, on and/or at the upper portion such that an inhaled airflow can run substantially straight from the air outlet of the respiratory filter through the upper portion, towards the lower portion and/or to a nose of a mask wearer when the respiratory protection mask is worn by the mask wearer.

49. The respiratory protection mask according to claim 48, wherein the respiratory filter comprises a curved forehead-facing side, wherein the respiratory filter comprises a curved frontal side arranged opposite the forehead-facing side, and/or wherein the respiratory filter is, in a cross-section perpendicular to a direction of the inhaled airflow, substantially sickle-shaped.

50. The respiratory protection mask according to claim 49, wherein the respiratory filter comprises at least one of: a filter body providing the curved forehead-facing side and the curved frontal side, a filter housing providing the curved forehead-facing side and the curved frontal side, and a filter material arranged in the filter housing and being curved in accordance with the curved forehead-facing side and the curved frontal side.

51. The respiratory protection mask according to claim 50, wherein the filter housing comprises a synthetic material, wherein the filter housing is made in one or two pieces, and/or wherein the filter housing comprises a handle, and/or can be opened and/or closed.

52. The respiratory protection mask according to claim 49, wherein a radius of curvature of the forehead-facing side and/or the frontal side is in a range from about 9 cm to about 90 cm, in particular in a range from about 10 cm to about 30 cm.

53. The respiratory protection mask according claim 48, further comprising a further respiratory filter arranged in, on and/or at the lower portion for filtering an exhaled airflow.

54. The respiratory protection mask according claim 53, wherein the further respiratory filter is arranged next to a chin of the mask wearer when the respiratory protection mask is worn.

55. The respiratory protection mask according to claim 48, further comprising a fan arranged in, on and/or at the lower portion for facilitating an exhaled airflow.

56. The respiratory protection mask according claim 55, wherein the fan is arranged next to a chin of the mask wearer when the respiratory protection mask is worn.

57. The respiratory protection mask according to claim 48, wherein the mask is a passive mask.

58. The respiratory protection mask according to claim 48, wherein the inhaled airflow extends substantially vertically from a forehead region to the nose of the mask wearer when the respiratory protection mask is worn by the mask wearer or wherein the inhaled airflow extends from a temple region to the nose of the mask wearer when the respiratory protection mask is worn by the mask wearer.

59. The respiratory protection mask according to claim 48, wherein the respiratory protection mask is a full-face mask.

60. The respiratory protection mask according to claim 48, comprising a frame providing a filter holder comprising a receptacle for the respiratory filter, wherein the respiratory filter can be fixed in the receptacle by means of locking lugs.

61. The respiratory protection mask according to claim 48, further comprising a support for a pair of spectacles arranged in the upper portion.

62. The respiratory protection mask according to claim 48, further comprising an at least substantially transparent chamber separation which, when the respiratory protection mask is worn by the mask wearer, divides an interior space of the mask into an eye compartment and an oral compartment.

63. The respiratory protection mask according to claim 62, wherein the chamber separation is, in a projection onto a vertical plane and/or in a frontal view, substantially V-shaped, and/or configured to extend substantially horizontally between a window of the respiratory protection mask and a face of the mask wearer.

64. The respiratory protection mask according to claim 48, wherein the respiratory filter further comprises at least one of: a detector for airborne particles, an air flow meter, a time of use detector, and/or time of use indicator.

65. The respiratory protection mask according to claim 49, further comprising an at least substantially transparent window forming a front side of the protection mask, wherein the frontal side of the respiratory filter is curved in accordance with an uppermost portion of the window.

66. A respiratory protection mask comprising:
a respiratory filter, wherein the mask is designed in such a way that the respiratory filter is arranged substantially above nostrils of a mask wearer when the respiratory protection mask is worn, and wherein the respiratory filter is substantially sickle-shaped when seen from above.

67. A respiratory protection mask comprising:
a curved viewing window which at least substantially forms a front side of the protection mask, and which, when the respiratory protection mask is worn by a mask wearer, extends from an eye region of the mask wearer over a mouth region of the mask wearer so that the mouth of the mask wearer is visible; and
a respiratory filter comprising a frontal side curved in accordance with an uppermost portion of the viewing window.
